(19) United States
(12) Patent Application Publication
(10) Pub. No.: US 2007/0059406 A1
(43) Pub. Date: Mar. 15, 2007

(54) FOOD PACKAGE HAVING SEPARATE GAS ATMOSPHERES

(75) Inventor: Farzad Shahsavarani, River Forest, IL (US)

Correspondence Address: LEVENFELD PEARLSTEIN;Intellectual Property Department, 2 North LaSalle, Suite 1300, CHICAGO, IL, 60602, US

(73) Assignee: GOURMET KITCHENS, INC., Chicago, IL (US)

(21) Appl. No.: 11/531,543

(22) Filed: Sep. 13, 2006

Related U.S. Application Data
(60) Provisional application No. 60/717,086, filed on Sep. 14, 2005.

(51) Int. Cl. A23B 7/148

(52) U.S. Cl. 426/106

(57) ABSTRACT

A food package having multiple containers with separate gas atmospheres for storing foods. A first container comprises a plastic bowl and a second container comprises a plastic tray configured to fit within the bowl. The tray includes a plurality of compartments configured to discretely store different foods. The tray is film sealed in an atmosphere configured to maintain the particular foods stored in the tray. The bowl is film sealed, with the film sealed tray inside, in an atmosphere configured to maintain the particular foods stored in the bowl. An optional lid may be applied to the top of the bowl. The atmosphere in the tray and the atmosphere in the bowl preferably are different, and preferably are modified from a standard atmosphere, the exact composition of each atmosphere dependent upon the particular foods and/or food components stored therein. In some embodiments, either the bowl or the tray may be sealed in a standard atmosphere, while the other container is sealed in a modified atmosphere. In some embodiments, such as when the bowl contains a standard atmosphere, the bowl may not be film sealed, but instead may be fitted only with a lid.

### CROSS-REFERENCE TO RELATED APPLICATIONS

This application claims the benefit of U.S. Provisional patent Application Ser. No. 60/717,086, filed on Sep. 14, 2005.

### BACKGROUND OF THE INVENTION

The present invention relates to food packaging and a method of preparing food packaging to maintain foods fresh over a desirable period of time. More particularly, the present invention concerns a food package with discrete containers, each container having separate gas atmosphere, and combining those containers into a single assembled unit. The food packaging and method of preparing food packing of the present invention provides a solution to packaging salads and other meals having multiple components that require different atmospheres during storage.

Healthful foods, such as salads, are an important part of a balanced diet and a healthy lifestyle. The demand for such foods continues to grow, as does the need to package such foods in a convenient and easily portable manner. For example, packaged fresh salads are readily available for purchase at grocery stores, convenience stores, airports, sporting events and the like, so consumers may enjoy the benefits of healthy eating “on-the-go.”

Fresh salads, meals and other foodstuffs typically are packaged in a manner consistent with keeping the entirety of the product fresh for a short period time, from manufacture through sale and consumption. Such packaging often uses conventional food packaging techniques, such as plastic or foil wraps, sealed plastic bowls or containers and other known storage materials. However, such packaged fresh salads typically have a relatively short shelf life, as salad ingredients tend to deteriorate rapidly after only a short time. Such deterioration is an undesirable by-product of the many natural processes, such as oxidation and respiration that may occur within the package atmosphere.

Moreover, packaging of food products often is done under standard atmospheric conditions, with little concern for the atmosphere within the package and its potentially undesirable effect on the longevity and appearance of the packaged product. Standard atmospheric conditions, in this sense, refer to a “normal” atmosphere containing about 78% nitrogen, about 21% oxygen and about 1% other gases, such as carbon dioxide.

Under standard atmospheric conditions, however, many foods tend to spoil rapidly due to moisture loss or gain, reaction with oxygen and/or the growth of aerobic microorganisms, such as bacteria and molds. This can cause undesirable changes in the texture, color, flavor and nutritional value of the food, rendering the food not only unpalatable, but also potentially unsafe.

Thus, it is known in the prior art to store foods in modified gaseous atmospheres using packaging of appropriate permeability to control the atmosphere in the package over an extended period. Storage of foods in modified gaseous atmospheres can maintain food quality and extend product shelf life by slowing or preventing the various chemical and biochemical reactions that lead to food spoilage, and can reduce and, in some cases, eliminate the need for food preservatives which may be deemed undesirable by consumers of fresh food products.

Such technology, known as modified atmosphere packaging (“MAP”), controls the chemical, enzymatic and microbiological reactions of foods, resulting in an extended shelf life. The three main gases typically used in MAP are carbon dioxide (CO₂), nitrogen (N₂) and, in some cases, oxygen (O₂), as well as a mixture of these gases. The choice of gas(es) is dependent upon the food product being packed. In some applications, the prior art has used noble gases, such as argon (Ar), helium (He), xenon (Xe) and neon (Ne) for products such as coffee and potato-based snack products. Additionally, experimental use of carbon monoxide (CO) and sulfur dioxide (SO₂) has also been reported in the prior art.

When packaging fresh fruits and vegetables, a modified atmosphere having a reduced level of oxygen is desired to avoid anaerobic respiration and to slow spoilage. However, when packaging fresh meats, an increased level of oxygen is desired in order to maintain the color of the meat. Moreover, when packaging meat, high carbon dioxide levels are preferred in order to inhibit bacterial and fungal grown. But, high carbon dioxide levels are undesirable for fresh fruit and vegetables since excessive carbon dioxide is phytotoxic and results in premature spoilage.

Thus, packaging a fresh salad (or any other food product comprised of multiple component food parts) creates unique challenges. A fresh salad may be comprised of numerous distinct components—greens (such as lettuce), carrots, tomatoes, meats, cheeses, croutons, dressings and the like—each with its own susceptibility to spoilage under various conditions and each with its own ideal atmospheric conditions to avoid or slow spoilage. Developing a single modified atmosphere to sufficiently addresses the various, and sometimes competing, atmospheric needs of the components of such a food product can be difficult, if not impossible.

Accordingly, there exists a need for food package that maintains the freshness and sanitation of a food product over an extended period of time. Desirably, such a food package provides a modified atmosphere to control the chemical processes that lead to deterioration and spoilage of the packaged food product. More desirably, such a food package provides for multiple discrete containers to hold various components of a final food product, such as a salad, each container having a different atmosphere. Most desirably, such a food package allows the multiple discrete containers to be combined into a single assembled unit.

### BRIEF SUMMARY OF THE INVENTION

The present invention comprises a food package having multiple containers with separate gas atmospheres for storing foods that comprise either an entire meal, or coordinated components of a meal that can be combined prior to consumption. In the preferred embodiment, the food package of the present invention comprises a first container for primary storage and a second container for secondary storage of different or varied foodstuffs. The first container comprises a plastic bowl and the second container comprises a plastic tray. In the preferred embodiment, the tray is configured to fit within the bowl and the bowl is configured to hold the tray. Preferably, the tray includes a plurality of compartments configured to discretely store certain components of a meal.

In the preferred embodiment, the second container is filled with various foods and/or food components and then sealed in an appropriate modified atmosphere, and using an appropriate film, configured to maintain the particular foods and/or food components in the second container. The first container then is filled with various foods and/or food components and the second container is inserted into the first container. The first container is sealed in an appropriate modified atmosphere, and using an appropriate film, configured to maintain the foods and/or food components in the first container. In some embodiments, a snap-on plastic lid may be applied to the top of the second container and over the film.

The modified atmosphere in the first container and the modified atmosphere in the second container preferably are different, the exact composition of each atmosphere dependent upon the particular foods and/or food components stored therein. However, the modified atmospheres of each container are configured to help preserve the freshness and hygienic nature of the foods and/or food components stored therein. In the preferred embodiment, the modified atmospheres typically comprise a mix of nitrogen, oxygen and/or carbon dioxide.

In some embodiments of the present invention, either the first container or the second container may be sealed in a standard atmosphere, while the other container is sealed in a modified atmosphere. Moreover, in some embodiments, such as when the first container contains a standard atmosphere, the first container may not be sealed with a plastic film, but instead may be fitted only with a snap-on plastic lid.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is an exploded perspective view of the preferred embodiment of the modified gas atmosphere food package of the present invention;

FIG. 2 is a top view of the first container of the modified gas atmosphere food package of the present invention; and,

FIG. 3 is a side perspective view of the second container of the modified gas atmosphere package of the present invention.

### DETAILED DESCRIPTION OF THE INVENTION

While the present invention is susceptible of embodiment in various forms, there is shown in the drawings and will hereinafter be described several preferred embodiments with the understanding that the present disclosure is to be considered an exemplification of the invention and is not intended to limit the invention to the specific embodiments illustrated.

It should be further understood that the title of this section of the specification, namely, “Detailed Description of the Invention,” relates to a requirement of the United States Patent and Trademark Office, and does not imply, nor should be inferred to limit the subject matter disclosed herein.

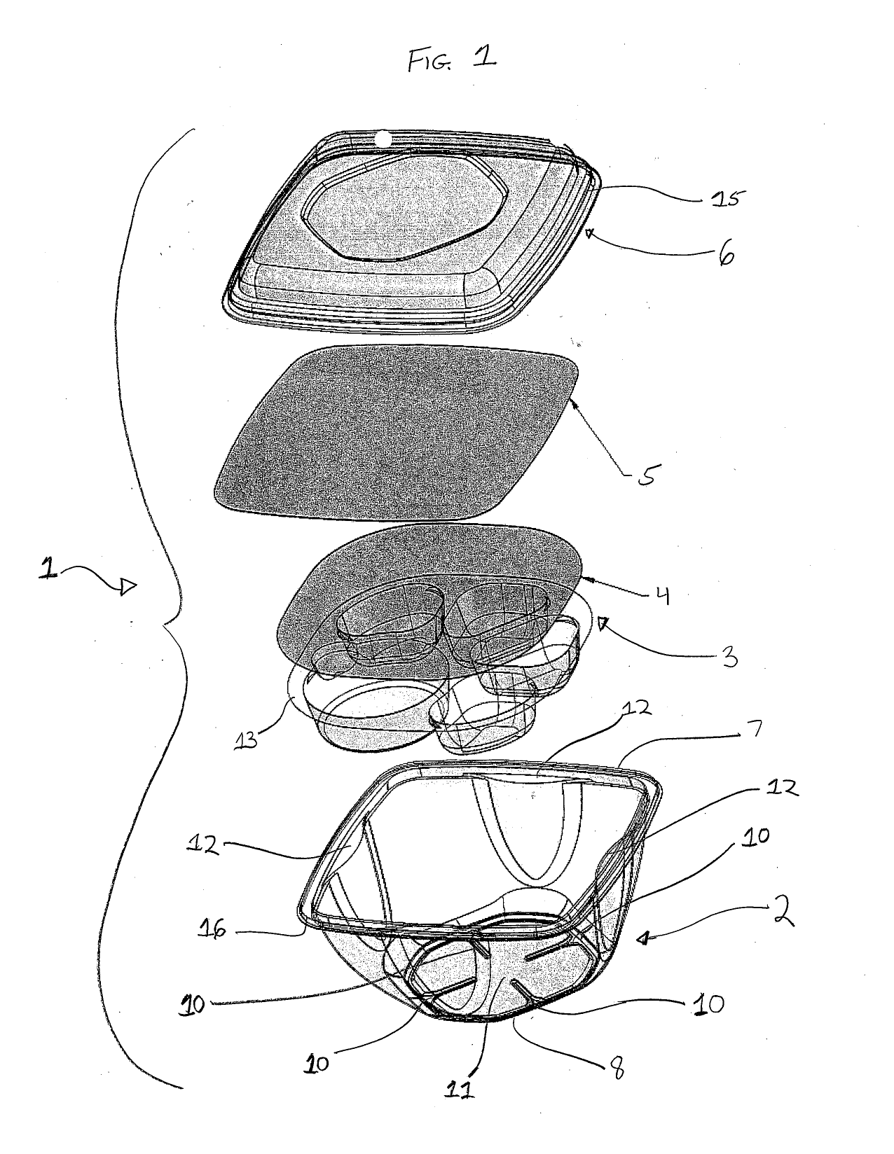

Referring to FIG. 1, a modified gas atmosphere food package 1 according to the present invention is shown. In the preferred embodiment, package 1 comprises a bowl 2 for storage of a first food product, a tray 3 for storage of a second food product, a tray film 4 for sealing the second food product in tray 3, a bowl film 5 for sealing tray 3 in bowl 2 and for sealing the first food product in bowl 2 and a lid 6 for sealing bowl 2 once bowl film 5 is unsealed from bowl 2.

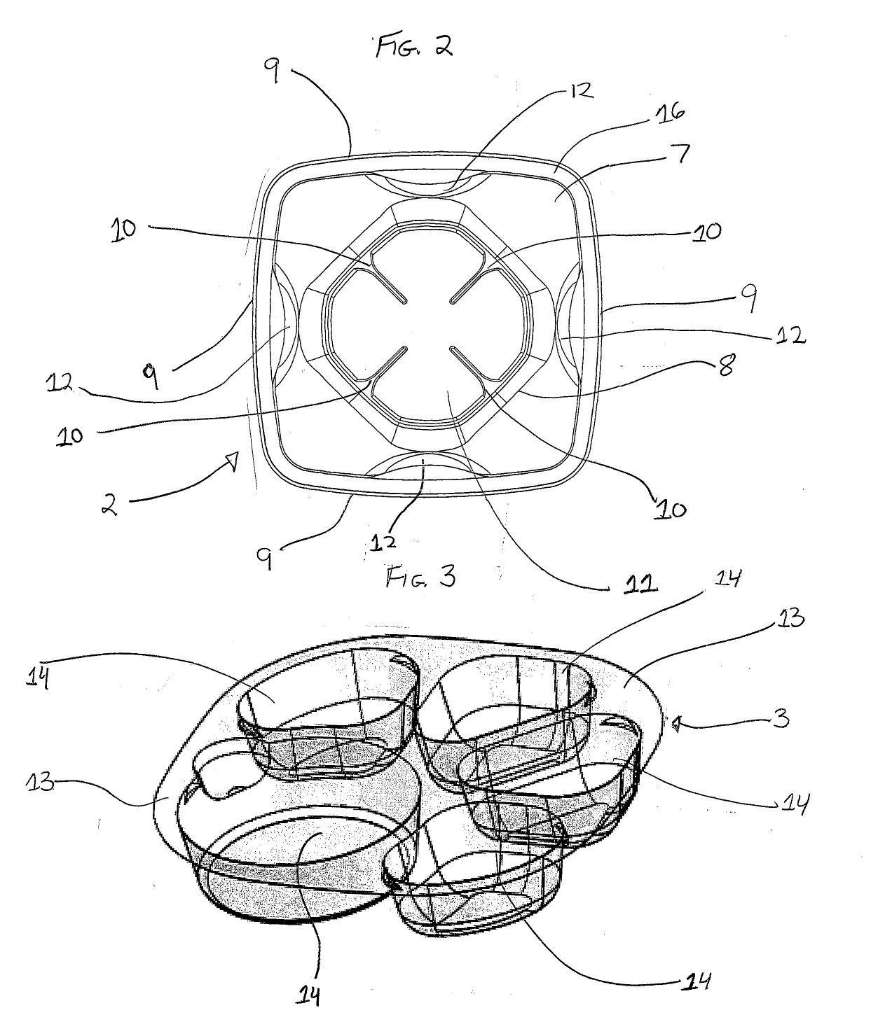

As shown in FIGS. 1 and 2, in the preferred embodiment, the first container comprises a bowl 2. Bowl 2 is constructed of an appropriately rigid, lightweight material. Additionally, bowl 2 preferably is transparent so as to permit the contents thereof to be viewed through the bowl. If the food product to be stored in package 1 is a salad, for example, bowl 2 is configured to hold the primary food component for the salad, namely greens, such as lettuce. However, any desired food product may be stored in bowl 2.

In the preferred embodiment bowl 2 is comprised of polyethylene terephthalate (PET) plastic. However, as those skilled in the art will recognize, numerous alternate materials may be used for bowl 2, such as amorphous polyethylene terephthalate (APET), polypropylene (PP), polylactic (PLA) and other plastics. Depending upon the particular foods and/or food components to be stored in bowl 2, and the particular composition of bowl film 5 (discussed below), the composition of bowl 2 may or may not include a barrier capability. Those skilled in the art will recognize the various combinations of foods and films that may require bowl 2 to have a barrier capability.

Bowl 2 is configured in the preferred embodiment with a generally square open top 7 and a generally octagonal base 8. Bowl 2 further comprises four walls 9 disposed between top 7 and base 8. Walls 9 are slightly concave in the preferred embodiment and are configured to promote circulation of gases within bowl 2. Such circulation provides efficient and consistent refrigeration of the contents of bowl 2 during transport.

Base 8 further comprises in the preferred embodiment raised cloverleaf-shaped platform 11 disposed on the interior surface of base 8. Platform 11 forms a plurality of ridges 10 disposed around the perimeter of base 8 and extending radially towards the center of base 8. Ridges 10 are configured to collect moisture from the contents of bowl 2 and to promote circulation of gases within bowl 2. Moreover, platform 11 and ridges 10 add rigidity and overall strength to bowl 2.

Walls 9 of bowl 2 in the preferred embodiment are indented to form ledges 12. Ledges 12 are configured to matingly receive tray 3 within bowl 2 and to suspend tray 3 above the contents of bowl 2 during packaging and transport.

It will be appreciated that the shape and design of bowl 2 in the preferred embodiment permits bowl 2 not only to stand upright on base 8, but also to rest on its side (on any one of wall 9). This flexibility allows package 1 to be transported in an upright position, but displayed for sale (such as in a commercial refrigeration case) in either an upright (vertical) or a side (horizontal) position.

It will be recognized, however, that bowl 2 may be configured in any number of shapes and sizes without departing from the scope and spirit of the present invention, and that use of the word “bowl” is not intended to limit the shape of the first container to a bowl. All such shapes, sizes and configurations of bowl 2 that allow a food product to be stored in bowl 2 in one atmosphere and another food product to be stored in a separate container having a different atmosphere, the separate container also disposed in bowl 2, are included within the scope of the present invention.

Package 1 further comprises a second container for storage of foods and/or food components in a different atmosphere than the atmosphere in bowl 2. In the preferred embodiment, the second container comprises tray 3. As shown in FIGS. 1 and 3, in the preferred embodiment tray 3 is constructed of an appropriately rigid, lightweight material, like bowl 2. Additionally, tray 3 preferably is transparent so as to permit the contents thereof to be viewed through the bowl.

In the preferred embodiment tray 3 is comprised of polyethylene terephthalate (PET) plastic. However, as those skilled in the art will recognize, numerous alternate materials may be used for tray 3, such as amorphous polyethylene terephthalate (APET), polypropylene (PP), polylactic (PLA) and other plastics. Depending upon the particular foods and/or food components to be stored in tray 3, and the particular composition of tray film 4 (discussed below), the composition of tray 3 may or may not include a barrier capability. Those skilled in the art will recognize the various combinations of foods and films that may require tray 3 to have a barrier capability.

In the preferred embodiment, tray 3 generally is square-shaped and is configured of an appropriate size such that tray 3 fits within top 7 of bowl 2. Moreover, tray 3 is configured with a lip 13 around its perimeter. Lip 13 engages with ledges 12 of bowl 2 to support tray 3 within bowl 2 and to suspend tray 3 above the contents of bowl 2.

Tray 3 further is configured in the preferred embodiment with a plurality of compartments 14, compartments 14 configured to discretely store different food products. If the food product to be stored in package 1 is a salad, for example, compartments 14 of tray 3 may be configured to hold the secondary food components for the salad, namely meats, cheeses, croutons and dressing. However, any desired food products may be stored in tray 3. It will be appreciated that the number of compartments 14 in tray 3 may vary depending upon the number of different food components to be stored.

Moreover, it will be recognized that tray 3 may be configured in any number of shapes and sizes without departing from the scope and spirit of the present invention, and that use of the word “tray” is not intended to limit the shape of the second container to a tray. All such shapes, sizes and configurations of tray 3 that allow a food product to be stored in tray 3 in one atmosphere, allow tray 3 to be disposed within bowl 2 and allow bowl 2 to have a separate atmosphere from tray 3 are included within the scope of the present invention.

Package 1 further includes tray film 4 configured to seal tray 4 and bowl film 5 configured to seal bowl 2. As recognized by those skilled in the art, the composition of tray film 4 and bowl film 5 is chosen based on the nature of the food product to be stored in tray 3 and bowl 2, respectively. All compositions of tray film 4 and bowl film 5 that allow a food product to be stored in bowl 2 in one atmosphere and another food product to be stored in a different atmosphere in tray 3, tray 3 being disposed in bowl 2, are included within the scope of the present invention.

For example, when the food product to be stored in package 1 is a salad, bowl 2 preferably holds greens, such as lettuce. Since greens respire, bowl film 5 must be a permeable film in order to permit the transmissions of gases from and to bowl 2. Such permeable films are well known to those skilled in the art. In the preferred embodiment of the present invention, if bowl 2 holds greens, such as lettuce, and/or other fresh cut produce, bowl film 5 is comprised of a coextruded polyester film. Those skilled in the art will recognize the myriad of other permeable films that may be used to seal respiring food products, and such films are included within the scope of the present invention.

Similarly, when the food product to be stored in package 1 is a salad, tray 3 preferably holds meats, cheeses, croutons, dressing and/or other non-respiring food products in compartments 14. Since the food products in tray 3 are non-respiring, a permeable film is not required, and a non-permeable (or barrier) film is preferred. Such barrier films are well known to those skilled in the art, and include low density polyethylene (LDPE), polyvinyl chloride (PVA) ethylene vinyl acetate (EVA) and oriented polypropylene (OPP). In the preferred embodiment of the present invention, if tray 3 holds meats, cheeses, croutons, dressing and/or other non-respiring food products, tray film 4 may be comprised of a polyvinylidene chloride (PVDC) barrier polyester laminate film. Again, those skilled in the art will recognize the myriad of other barrier films that may be used to seal non-respiring food products, and such films are included within the scope of the present invention.

In some embodiments of the present invention, bowl film 5 may be omitted if it is desired to store the contents of bowl 2 in a standard atmosphere, while the contents of tray 3 remain discretely sealed in tray 3 and tray 3 is disposed within bowl 5. It will be appreciated that such an embodiment is included within the scope of the present invention. In such an embodiment, package 1 preferably includes lid 6, as discussed below, to seal bowl 2.

The preferred embodiment of package 1 also includes lid 6. Lid 6 is constructed of an appropriately rigid, lightweight material. Additionally, lid 6 preferably is transparent so as to permit the contents of tray 3 and bowl 2 to be viewed through lid 6.

Lid 6 preferably is comprised of the same material as bowl 2, namely polyethylene terephthalate (PET) plastic in the preferred embodiment. However, as those skilled in the art will recognize, numerous alternate materials may be used for lid 6 without departing from the scope of the present invention. Such materials include: amorphous polyethylene terephthalate (APET), polypropylene (PP), polylactic (PLA) and other plastics.

The design of lid 6 is known to those skilled in the art. Lid 6 generally is square-shaped and is configured to be slightly larger than open top 7 of bowl 2. Lid 6 includes a lip 15 around its perimeter configured to matingly engage a shoulder 16 formed around the perimeter of open top 7 of bowl 2.

Lid 6 may be used to seal bowl 2 once bowl film 5 is unsealed from bowl 2. Thus, if package 1 is used to package a salad, for example, once the salad components are mixed in bowl 2, any leftover salad remaining after consumption may be saved by securing lid 6 to bowl 2. It should be understood, however, that in some embodiments of the present invention lid 6 is optional.

It will be appreciated that package 1 of the present invention can be used to package a wide variety of food products having components that require separate atmospheres for ideal preservation conditions. However, the present invention has particular application to salads; thus, the following example focuses on salads.

To package a food product, such as a salad, using package 1 in the preferred embodiment of the present invention, compartments 14 in tray 3 are filled will the desired non-respiring salad ingredients, such as meats, cheeses, croutons dressings and the like. Tray 3 then is film sealed with tray seal 4 (as discussed above) in an appropriate atmosphere using a traysealer machine, such as the T 400 High-Speed Traysealer with full gas flushing, commercially available from Multivac Inc. (Kansas City, Mo.). Such traysealers are configured to remove the standard atmosphere from the tray, replace it with a desired modified atmosphere and seal the tray with a desired film material. The operation and capabilities of such traysealers are well known to those skilled in the art.

In the preferred embodiment, if tray 3 is filled with non-respiring salad ingredients, the traysealer is configured to replace the standard atmosphere in tray 3 with a modified atmosphere containing appropriate levels of gases designed to minimize spoilage of the non-respiring ingredients and maximize shelf life. For example, the modified atmosphere of tray 3 for non-respiring salad ingredients may comprise 30%, by volume, carbon dioxide, 50%, by volume, nitrogen and 20%, by volume, oxygen. However, those skilled in the art will recognize the wide variety of gases, tray film 3 materials, and combinations thereof, which may be used to modify the atmosphere of tray 3 and seal tray 3. The present invention is not limited to any particular modified atmosphere or tray film 4, but rather encompasses all atmospheres and tray films as long as the atmosphere of sealed tray 3 is different from the atmosphere of bowl 2.

Bowl 2 then is filled with the desired respiring salad ingredients, such as greens (lettuce) and other vegetables. Sealed tray 3 then is inserted into bowl 2, with lip 13 of tray 3 resting on ledges 12 of bowl 2, and bowl 2 is film sealed with bowl seal 5 (as discussed above) in an appropriate atmosphere using a similar traysealer machine.

In the preferred embodiment, if bowl 2 is filled with respiring salad ingredients, such as greens (lettuce) and other vegetables, the traysealer is configured to replace the standard atmosphere in bowl 2 with a modified atmosphere containing appropriate levels of gases designed to minimize spoilage of the respiring ingredients and maximize shelf life. For example, the modified atmosphere of bowl 2 for respiring salad ingredients may comprise 5%, by volume, carbon dioxide, 90%, by volume, nitrogen and 5%, by volume, oxygen. However, those skilled in the art will recognize the wide variety of gases, bowl film 5 materials, and combinations thereof, which may be used to modify the atmosphere of bowl 2 and seal bowl 2. The present invention is not limited to any particular modified atmosphere or bowl film 5, but rather encompasses all atmospheres and bowl films as long as the atmosphere of sealed tray 3 is different from the atmosphere of bowl 2.

In the preferred embodiment of the present invention, lid 6 is applied to bowl 2 after bowl 2 is sealed with bowl film 5. However, it will be appreciated that lid 6 is optional.

Furthermore, in some embodiments of the present invention, either bowl 2 or tray 3 may be sealed in a standard atmosphere, while the other container is sealed in a modified atmosphere, depending upon the particular food products stored in bowl 2 and tray 3. Moreover, in some embodiments of the present invention, such as when bowl 2 contains a standard atmosphere, bowl 2 may not be sealed with bowl film 5, but instead may be fitted only with lid 6.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

In the present disclosure, the words “a” or “an” are to be taken to include both the singular and the plural. Conversely, any reference to plural items shall, where appropriate, include the singular.

All patents referred to herein, are hereby incorporated herein by reference, whether or not specifically done so within the text of this disclosure.

What is claimed is:

1. A food package having separate gas atmospheres comprising:
a first container configured to store at least one first food product, the first container having a first atmosphere contained therein; and,
a second container configured to store at least one second food product, the second container having a second atmosphere contained therein;
wherein the second container is disposed within the first container; and
wherein the first atmosphere is different from the second atmosphere.

2. The food package of claim 1 wherein the first container further comprises a first container seal to contain the first atmosphere therein.

3. The food package of claim 1 wherein the second container further comprises a second container seal to contain the second atmosphere therein.

4. The food package of claim 1 wherein the first container is a bowl.

5. The food package of claim 1 wherein the second container is a tray.

6. The food package of claim 1 wherein the first atmosphere is configured to preserve the at least one first food product.

7. The food package of claim 1 wherein the second atmosphere is configured to preserve the at least one second food product.

8. The food package of claim 1 further comprising a lid disposed on the first container.

9. The food package of claim 1 wherein the second container further comprises a second container seal to contain the second atmosphere therein, and wherein the food package further comprises a lid disposed on the first container.

10. A food package having separate gas atmospheres comprising:
a first container configured to store at least one first food product;
a second container configured to store at least one second food product;
a first film disposed on the first container for sealing the first container and maintaining a first atmosphere therein; and
a second film disposed on the second container for sealing the second container and maintaining a second atmosphere therein;
wherein the second container is disposed within the first container; and
wherein the first atmosphere is different from the second atmosphere.

11. The food package of claim 10 wherein the first container is a bowl.

12. The food package of claim 10 wherein the second container is a tray.

13. The food package of claim 12 wherein the tray comprises a plurality of compartments.

14. The food package of claim 10 wherein the first atmosphere is configured to preserve the at least one first food product.

15. The food package of claim 10 wherein the second atmosphere is configured to preserve the at least one second food product.

16. The food package of claim 10 wherein the first atmosphere and the second atmosphere are comprised of at least one gas selected from the group of nitrogen, carbon dioxide, oxygen and mixtures thereof.

17. The food package of claim 10 further comprising a lid disposed on the first container.

18. The food package of claim 10 wherein the at least one first food product contains greens.

19. The food package of claim 18 wherein the at least one second food product comprises a food product selected from the group of meats, cheeses, croutons and salad dressing.

20. The food package of claim 10 wherein the first film disposed on the first container and the second film disposed on the second container are applied using a traysealer.

21. The food package of claim 20 wherein the first atmosphere and the second atmosphere are created using a traysealer.

22. A method of storing food products in a food package having separate gas atmospheres comprising the steps of:
providing a first container;
providing a second container;
adding at least one food product to the second container;
forming a second atmosphere in the second container;
sealing the second container to maintain the second atmosphere therein;
adding at least one food product to the first container;
inserting the second container into the first container;
forming a first atmosphere in the first container; and
sealing the first container to maintain the first atmosphere therein;
wherein the first atmosphere is different from the second atmosphere.
